(19) United States
(12) Patent Application Publication
(10) Pub. No.: US 2024/0391476 A1
(43) Pub. Date: Nov. 28, 2024

(54) METHOD FOR A CONTINUOUS INTEGRATION APPROACH OF DRIVER ASSISTANCE SYSTEMS

(71) Applicant: Dr. Ing. h.c. F. Porsche Aktiengesellschaft, Stuttgart (DE)

(72) Inventor: Moritz Markofsky, Bruchsal (DE)

(21) Appl. No.: 18/619,317

(22) Filed: Mar. 28, 2024

(30) Foreign Application Priority Data
May 23, 2023 (DE) 10 2023 113 400.0

(51) Int. Cl. B60W 50/04; B60W 60/00

(52) U.S. Cl. CPC B60W 50/045; B60W 60/001; B60W 2050/046; B60W 2556/00; B60W 2756/10

(57) ABSTRACT

A method uses a continuous integration approach for improving driver assistance systems. The method uses a test data set (11) with a time series of input data and output data of the driver assistance system and is formed during driving in a real traffic. A system-under-test is formed by a continuously changed overall software. A data-driven validation is carried out at predetermined time intervals. The method simultaneously matches (14) the output of a current software version with ground-truth data (13), which results in an assessment of a performance of the current software version and continues by forming a performance statistic on all differences and their performance score and evaluating the changes to the overall software.

### CROSS-REFERENCE TO RELATED APPLICATION

This application claims priority on German Patent Application No 10 2023 113 400.0 filed May 23, 2023, the entire disclosure of which is incorporated herein by reference.

### BACKGROUND

Field of the Invention The disclosure relates to a method for a continuous integration approach to improve driver assistance systems based on data-driven validation. The disclosure also relates to a test system that uses a continuous integration approach for improving driver assistance systems.

Related Art A continuous integration approach describes a method from software development in which a current state of a software project is compiled and tested automatically at short intervals (e.g., daily). This makes it possible to detect and fix errors very early on and at a stage where the errors are still small in impact on the continuously evolving software project. A prerequisite for this continuous integration approach is a continuous availability of compilable and testable overall software of the software project.

Automated Driver Assist Systems (ADAS) and Automated Driving Systems (ADS) use sensors on a vehicle and external devices or data feeds that communicate with the vehicle to help a driver respond to current conditions or to cause the vehicle to respond without direct driver input. For example, an ADAS or ADS is capable of performing certain driving maneuvers or assisting the driver in performing certain driving maneuvers, such as accelerating, decelerating, braking, steering, vibrating the steering wheel, producing audio or visual alerts or the like based on information sensed by the vehicle or otherwise communicated to the vehicle, such as accident ahead, icy road ahead or the like. The large number of inputs that must be considered by an ADAS or ADS, the speed at which those inputs change independently of one another or change with dependence on one another, the speed at which reactions must be made and the way in which one reaction affects other required reactions make periodic complete revisions to an ADAS or ADS difficult and costly. Inputs must be assessed and ADAS/ADS reactions must be made essentially in real time. Simple pen and paper evaluations to identify problems or develop solutions are effectively impossible.

Continuous integration approaches have been applied only to limited to simple sub-component verification testing with respect to Automated Driver Assist Systems (ADAS) and Automated Driving Systems (ADS). More particularly, continuous integration approaches have been tried in simple test cases, such as HMI (human machine interface) tests and tests regarding communication with partner control devices. However, many relevant test cases or traffic scenarios are not tested. This is because these test cases are very complex to reproduce and also usually are not known at all or lack a description.

ADAS/ADS also has the property of functional inadequacy. This means that all scenarios occurring in traffic would have to be processed correctly by the driver assistance systems. However, a number of these scenarios are so large that they are not all known and cannot be described in a specification. As a result, specification-derived verification testing of continuous integration approaches is also incomplete.

U.S. Pat. No. 10,255,168 discloses a method for generating test cases for autonomous vehicles. The test cases are generated automatically based on data from vehicles participating in public road traffic.

US 2021/0103283 A1 discloses a simulation system for simulating autonomous motor vehicle where the simulation system processes sensor data from traffic scenarios, and errors and problems are automatically found using a continuous integration approach.

DE 10 2019 134 053 A1 describes an application method for driving assistance systems where new application states are tested with regard to their performance by means of a continuous integration environment.

In light of this, an object of the invention is to provide a method and system for a continuous integration approach to a driver assistance system where an overall software of the driver assistance system is tested in day-to-day traffic situations. Test cases to be considered should go beyond simply structured test cases and can also cover customer-specific scenarios.

### SUMMARY OF THE INVENTION

A method is provided for a continuous integration approach of driver assistance systems where measurement data are measured by vehicle sensors while driving of a vehicle in real traffic, and vehicle actuator settings are determined. The measurement data and settings are stored in a test data set that comprises a time series of input data and output data of the driver assistance system. The test data set is used to test a system-under-test where an automated driver assistance system (ADAS) or an automated driving system (ADS) is selected as the system-under-test. The ADAS or ADS is capable of performing certain driving maneuvers or assisting the driver in performing certain driving maneuvers, such as accelerating, decelerating, braking, steering, vibrating the steering wheel, producing audio or visual alerts or the like based on information sensed by the vehicle. This disclosure encompasses such ADAS and ADS features that are known in the prior art and those that are yet to be developed. The system-under-test is formed or represented by an overall software, with the overall software being continuously changed. The following steps of a data-driven validation are performed repeatedly at predetermined time intervals:
loading a current software version of the overall software forming the system-under-test onto a server;
compiling the current software version on the server to an executable computer program (thus simultaneously testing compilability);
transferring the computer program to a hardware-in-the-loop test bench (thus simultaneously testing a transfer operation, such as by flashing);
loading the test data set onto the hardware-in-the-loop test bench;
running the computer program on the hardware-in-the-loop test bench while feeding the input data to the test data set;
logging a respective difference in output between the current software version and the output data of the test data set;
simultaneously matching the output of the current software version with ground-truth data, thereby inferring an improvement or deterioration of a performance of the current software version and assigning a performance score to the respective differences;
forming a performance statistic on all differences and their performance score; evaluating changes in the overall software based on the performance statistic; and outputting a report.

The changed overall software is executed during controlling of a real vehicle in real time.

The method advantageously enables automatic validation of a driver assistance system under customer-specific operation. These automated tests do not require a human test engineer, and hence can be run around the clock in real time with respect to events occurring in the vehicle.

In one embodiment of the method, the test data set is generated from at least one of the following sources: customer vehicles that participate in normal road traffic, vehicles that participate in a test of the system-under-test in normal road traffic.

In a further embodiment, the test data set is formed from at least one time series belonging to: sensor data, map material, traffic conditions, output of the driver assistance system.

In a continued further embodiment, newly occurring system-under-test errors are listed by the report during validation iteration.

In still a further embodiment of the method, an open loop ADAS/ADS is tested as a system-under-test.

The system-under-test may be formed by one of the following open-loop driver assistance systems: traffic sign recognition, night vision, ego motion locator.

In another embodiment, at least one subcomponent of a closed-loop system is tested using concepts of functional decomposition. In this case, the closed-loop system comprises at least one closed-loop subcomponent and at least one open-loop subcomponent. The at least one open-loop subcomponent is selected as the at least one subcomponent to be tested. Thus, for example, in a distance control cruise control, all perception components or a lateral control can be tested as open-loop subcomponents. This represents a particularly advantageous embodiment of the method because a closed-loop system generally cannot be tested based on recorded and thus non-changeable data, since any output of the close-loop system would in turn have repercussions on the input data.

Some embodiments use a plurality of test benches in parallel by partitioning the test data sets into plural time periods and supplying the test data sets to the respective test benches at the respective time periods. Real-time test procedures must be performed when using hardware-in-the-loop test benches. A faster run advantageously can be effected by the partitioning of the test data sets.

Changes in the software version may be discarded according to the evaluation. A new iteration run then is started.

The invention also relates to a test system for a continuous integration approach of driver assistance systems. The test system comprises a server and a hardware-in-the-loop test bench having a computing unit. The computing unit is configured to execute an algorithm according to a method described herein.

Further advantages and embodiments of the invention will emerge from the description and the accompanying drawings.

It is understood that the aforementioned features and the features yet to be explained in the following can be used not only in the respectively specified combination, but also in other combinations or on their own, without departing from the scope of the invention.

In an example embodiment of the method according to the invention, a continuous integration approach for systems with functional inadequacy is presented below. By way of example, the system-under-test is formed by a traffic sign recognition software. Video data and bus signals are available from customer data or from tests that have been conducted. Changes to the traffic sign recognition software developed throughout the day are loaded onto a server every evening. These changes can include, for example, recognition algorithms, map data, legislative data sets, and fusion algorithms. The current software version on the server is compiled and automatically run on a computing unit in a hardware-in-the-loop test bench. First test cases for compilability and flashability of the software already are performed here. The recorded data then are fed to the hardware-in-the-loop test bench, so that the testing is run again “virtually” with the new software. At the same time, the output of the software, i.e. the traffic sign displayed to the customer, is matched with ground-truth data. A statistic is derived from this as to whether the software changes resulted in an improvement or a deterioration of the performance of the ADAS/ADS. A final report may include this statistic and additional information about newly arising errors during data-driven validation, such as infrequently occurring scenarios that lead to errors with the new software, for example.

### BRIEF DESCRIPTION OF THE DRAWING

FIG. 1 is a flowchart of a continuous integration approach of an embodiment of the system of the invention.

### DETAILED DESCRIPTION

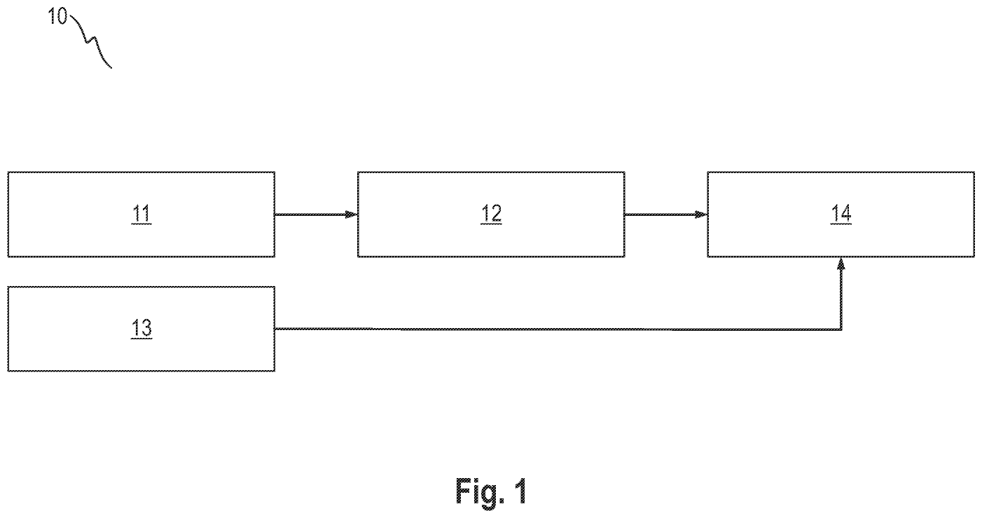

FIG. 1 is a flowchart 10 that illustrates a continuous integration approach in an embodiment of the system according to the invention. Measurement data 11, measured and recorded in real traffic by vehicle sensors, forms the basis for a test data set for a system-under-test 12, and is performed on a hardware-in-the-loop test bench and thus passes through a variety of driving scenarios. Output data are matched 14 with related ground truth data 13, and an improvement or deterioration of a performance of a current software version of the system-under-test 12 is inferred from the comparison 14

### LIST OF REFERENCE SIGNS

10 Continuous Integration ApproachFlowchart
11 Recorded Data
12 System-under-test (SUT)
13 Related Ground-Truth Data
14 Match Output Data with Ground-Truth Data

1. A method that uses a continuous integration approach for improving driver assistance systems installed in vehicles, the method comprising:
using sensors on the vehicles for measuring vehicle operating data while driving the respective vehicles in real traffic;
determining vehicle actuator settings based on the operating data sensed by the sensors;
storing the measured vehicle operating data and the vehicle actuator settings in a test data set (11) that comprises time series of input data and output data of the driver assistance system;
testing a system-under-test (12) with the test data set (11), the system-under-test (12) being formed by an overall software that is changed continuously;
performing data-driven validations repeatedly at predetermined time intervals, each iteration of the data-driven validations including the steps of:
loading a current software version of the overall software forming the system-under-test (12) onto a server;
compiling the current software version on the server into an executable computer program;
transferring the computer program to a hardware-in-the-loop test bench;
loading the test data set (11) onto the hardware-in-the-loop test bench;
running the computer program on the hardware-in-the-loop test bench while feeding the input data to the test data set;
logging differences in output between the current software version and the output data of the test data set;
simultaneously matching (14) the output of the current software version with ground-truth data (13), thereby inferring an improvement or deterioration of a performance of the current software version and assigning a performance score to the respective differences;
forming a performance statistic on all differences and their performance score;
evaluating changes in the overall software based on the performance statistic;
outputting a report; and
executing the changed overall software during controlling of a real vehicle.

2. The method of claim 1, wherein the test data set (11) is generated from at least one of: customer vehicles that participate in normal road traffic, vehicles that participate in a test of the system-under-test in normal road traffic.

3. The method of claim 1, wherein the test data set (11) is formed by at least one time series of data selected from: sensor data, map material, traffic conditions, and output of the driver assistance system.

4. The method of claim 1, wherein the report lists any new system-under-test (12) errors that occurred during any one of the data-driven validation iterations.

5. The method of claim 1, wherein the system-under-test (12) is an automated driver assistance system (ADAS) or an automated driving system (ADS).

6. The method of claim 5, wherein system-under-test (12) is an open loop ADAS or ADS.

7. The method of claim 5, wherein the system-under-test (12) is an open-loop ADAS or ADS that comprises at least one of traffic sign recognition, night vision, ego motion locator.

8. The method of claim 1, further comprising testing at least one subcomponent of a closed-loop system using functional decomposition, wherein the closed-loop system comprises at least one closed-loop subcomponent and at least one open-loop subcomponent, and wherein the at least one open-loop subcomponent is selected as the at least one subcomponent to be tested.

9. The method of claim 1, further comprising using a plurality of the test benches in parallel by partitioning the test data sets (11) into a plurality of time periods and supplying test data sets (11) to the respective test benches at the respective time periods.

10. The method of claim 1, wherein based on the evaluating of the changes in the overall software based on the performance statistic, respective changes in the software version are discarded and a new iteration run is started.

11. A test system that uses a continuous integration approach for improving driver assistance systems installed in vehicles, the test system comprises a server and a hardware-in-the-loop test bench having a computing unit, the computing unit being configured to execute an algorithm according to the method of claim 1.
